(19) United States
(12) Patent Application Publication
(10) Pub. No.: US 2026/0300810 A1
(43) Pub. Date: Oct. 1, 2026

(54) DISTRIBUTED UPDATING OF MACHINE LEARNING MODELS

(71) Applicant: Dell Products L.P., Round Rock, TX (US)

(72) Inventors: Mustafa AlBado, Cork (IE); Srinath Kappgal, Cork (IE); Zijia Wang, London (GB)

(21) Appl. No.: 19/093,484

(22) Filed: Mar. 28, 2025

(51) Int. Cl. G06N 20/00

(52) U.S. Cl. CPC G06N 20/00

(57) ABSTRACT

An apparatus comprises at least one processing device configured to maintain, by a first entity, a first machine learning model associated with a label distribution of classifications for features characterizing operation of information technology assets running in an information technology infrastructure. The at least one processing device is also configured to generate residual labels characterizing portions of the label distribution not captured by the first machine learning model, to provide the residual labels to additional entities, and to receive from the additional entities partial predictions characterizing predicted classifications for the residual labels based on subsets of the features characterizing the operation of the information technology assets locally available at the additional entities. The at least one processing device is further configured to update one or more parameters of the first machine learning model based at least in part on an aggregation of the partial predictions received from the additional entities.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). In some cases, multi-party learning is used where multiple parties collaboratively train AI/ML models while each party keeps its private data confidential.

### SUMMARY

Illustrative embodiments of the present disclosure provide techniques for distributed updating of machine learning models.

In one embodiment, an apparatus comprises at least one processing device comprising a processor coupled to a memory. The at least one processing device is configured to maintain, by a first entity, a first machine learning model, the first machine learning model being associated with a label distribution of classifications for sets of features characterizing operation of information technology assets running in an information technology infrastructure. The at least one processing device is further configured to generate residual labels for the first machine learning model, the residual labels characterizing portions of the label distribution not captured by the first machine learning model maintained by the first entity, and to provide, to one or more additional entities, the residual labels. The at least one processing device is further configured to receive, from the one or more additional entities, partial predictions characterizing predicted classifications for the residual labels generated utilizing additional machine learning models maintained by the one or more additional entities based at least in part on respective local subsets of the sets of features characterizing operation of the information technology assets running in the information technology infrastructure that are available to respective ones of the one or more additional entities. The at least one processing device is further configured to update one or more parameters of the first machine learning model maintained by the first entity based at least in part on an aggregation of the partial predictions received from the one or more additional entities.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for distributed updating of machine learning models in an illustrative embodiment.

FIG. 2 is a flow diagram of an exemplary process for distributed updating of machine learning models in an illustrative embodiment.

FIG. 3 shows inter-party transfer of knowledge in a multi-party learning framework in an illustrative embodiment.

FIG. 4 shows backflow distillation for knowledge transfer in a multi-party learning framework in an illustrative embodiment.

FIG. 5 shows an evolution of adaptive weights for passive parties in a multi-party learning framework in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

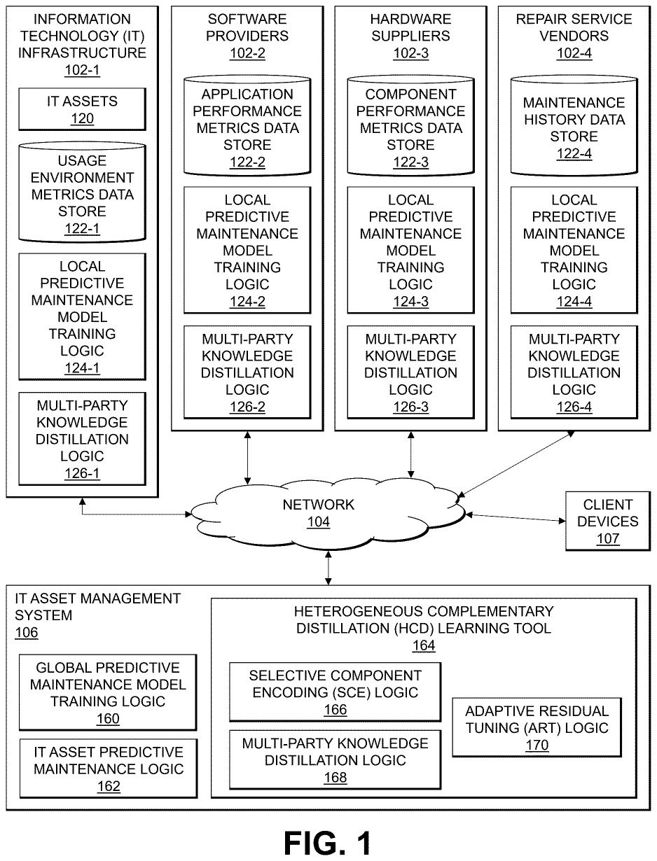

FIG. 1 shows an information processing system 100 configured in accordance with an illustrative embodiment. The information processing system 100 is assumed to be built on at least one processing platform and provides functionality for distributed updating of machine learning models. While some embodiments are described with respect to distributed updating of machine learning models used in information technology (IT) asset management processes (e.g., predictive maintenance services), the techniques described herein may be used in various other application scenarios involving multi-party learning frameworks in which it is desirable to provide for distributed updating of machine learning models. The information processing system 100 includes an IT infrastructure 102-1, one or more software providers 102-2, one or more hardware suppliers 102-3 and one or more repair service vendors 102-4, which are coupled to a network 104. The IT infrastructure 102-1 includes a set of IT assets 120, which may comprise physical and/or virtual computing resources in the IT infrastructure 102-1. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc. Also coupled to the network 104 is an IT asset management system 106.

In some embodiments, the IT asset management system 106 is used for an enterprise system. For example, an enterprise may operate the IT infrastructure 102-1 and subscribe to or otherwise utilize the IT asset management system 106 for performing predictive maintenance for the IT assets 120 of the IT infrastructure 102-1. To do so, the IT asset management system 106 implements a predictive maintenance service within a multi-party learning framework including the IT infrastructure 102-1, the software providers 102-2, the hardware suppliers 102-3 and the repair service vendors 102-4. In the multi-party learning framework, the IT asset management system 106 is the main or “active” party relative to the IT infrastructure 102-1, the software providers 102-2, the hardware suppliers 102-3 and the repair service vendors 102-4 which are collectively referred to and act as “passive” parties 102. The multi-party learning framework implements a predictive maintenance service, including a main or “global” machine learning model at the IT asset management system 106 operating as the main or active party and a set of “local” machine learning models at the passive parties 102. The multi-party learning framework illustratively enables cross-organization data collaboration to enhance accuracy while protecting confidential information.

As used herein, the term “enterprise system” is intended to be construed broadly to include any group of systems or other computing devices. For example, the IT assets 120 of the IT infrastructure 102-1 may provide a portion of one or more enterprise systems. A given enterprise system may also or alternatively include one or more client devices 107 coupled to the network 104 which access or utilize the IT assets 120 of the IT infrastructure 102-1 and/or the IT asset management system 106. The given enterprise system may also operate one or more of the software providers 102-2, the hardware suppliers 102-3 and the repair service vendors 102-4. In some cases, however different ones of the passive parties 102 are operated by different enterprises. In some embodiments, an enterprise system includes cloud infrastructure comprising one or more clouds implementing the passive parties 102 and/or the IT asset management system 106. A given enterprise system, such as cloud infrastructure, may host assets that are associated with multiple enterprises (e.g., two or more different businesses, organizations or other entities).

The client devices 107 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 107 may also or alternately comprise virtualized computing resources, such as VMs, containers, etc.

The client devices 107 in some embodiments comprise respective computers associated with a particular company, organization or other enterprise. Thus, the client devices 107 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

Although not explicitly shown in FIG. 1, one or more input-output devices such as keyboards, displays or other types of input-output devices may be used to support one or more user interfaces to the IT infrastructure 102-1, the software providers 102-2, the hardware suppliers 102-3, the repair service vendors 102-4, the IT asset management system 106 and the client devices 107, as well as to support communication between these and other related systems and devices not explicitly shown.

The IT asset management system 106 may be provided as a cloud service that is accessible by one or more of the client devices 107 to allow users thereof to implement a predictive maintenance service for performing predictive maintenance (e.g., fault or error detection, failure, etc.) for the IT assets 120 of the IT infrastructure 102-1. In some embodiments, the client devices 107 are assumed to be associated with users of an enterprise, organization or other entity that seeks to manage and perform predictive maintenance for the IT assets 120 of the IT infrastructure 102-1. In some embodiments, the client devices 107 are utilized by members of the same enterprise, organization or other entity that operates the IT asset management system 106. In other embodiments, the client devices 107 are utilized by members of one or more enterprises, organizations or other entities different than the enterprise, organization or other entity that operates the IT asset management system 106 (e.g., a first enterprise provides support functionality for multiple different customers, businesses, etc.). Various other examples are possible.

In some embodiments, the client devices 107, the IT assets 120 of the IT infrastructure 102-1, the software providers 102-2, the hardware suppliers 102-3 and/or the repair service vendors 102-4 may implement host agents that are configured for automated transmission of information with the IT asset management system 106 (e.g., training targets, intermediate model representations, refined model outputs, etc.). It should be noted that a “host agent” as this term is generally used herein may comprise an automated entity, such as a software entity running on a processing device. Accordingly, a host agent need not be a human entity.

The IT infrastructure 102-1, the software providers 102-2, the hardware suppliers 102-3, the repair service vendors 102-4 and the IT asset management system 106 in the FIG. 1 embodiment are assumed to be implemented using at least one processing device. Each such processing device generally comprises at least one processor and an associated memory, and implements one or more functional modules or logic for controlling certain features of the IT infrastructure 102-1, the software providers 102-2, the hardware suppliers 102-3, the repair service vendors 102-4 and the IT asset management system 106 to implement a multi-party learning framework. The multi-party learning framework includes “local” predictive maintenance machine learning models which are generated by each of the passive parties 102, utilizing respective instances of local predictive maintenance model training logic 124-1, 124-2, 124-3 and 124-4 (collectively, local predictive maintenance model training logic 124). Each of the passive parties 102 has access to different data utilized in generating the respective local predictive maintenance machine learning models. The IT infrastructure 102-1 generates and trains its local predictive maintenance machine learning model based on usage environment metrics associated with usage of the IT assets 120 maintained in usage environment metrics data store 122-1. The software providers 102-2 generate and train their local predictive maintenance machine learning model based on application performance metrics for software running on the IT assets 120 maintained in application performance metrics data store 122-2. The hardware suppliers 102-3 generate and train their local predictive maintenance machine learning model based on hardware component performance metrics for hardware components of the IT assets 120 maintained in the component performance metrics data store 122-3. The repair service vendors 102-4 generate and train their local predictive maintenance machine learning model based on maintenance history for the IT assets 120 maintained in maintenance history data store 122-4.

The usage environment metrics data store 122-1, the application performance metrics data store 122-2, the component performance metrics data store 122-3 and the maintenance history data store 122-4 are collectively referred to as data stores 122. The data stores 122 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The IT asset management system 106, acting as the active party in the multi-party learning framework, implements a “global” predictive maintenance machine learning model utilizing global predictive maintenance model training logic 160. The IT asset management system 106 further implements IT asset predictive maintenance logic 162, which utilizes the generated global predictive maintenance machine learning model for performing predictive maintenance for the IT assets 120 of the IT infrastructure 102-1. The IT asset management system 106 also implements a heterogeneous complementary distillation (HCD) learning tool 164 comprising selective component encoding (SCE) logic 166, multi-party knowledge distillation logic 168 and adaptive residual tuning (ART) logic 170.

In the multi-party learning framework, knowledge is shared among the passive parties 102 utilizing respective instances of multi-party knowledge distillation logic 126-1, 126-2, 126-3 and 126-4 (collectively, multi-party knowledge distillation logic 126), using inter-party transfer (IPT) of intermediate representations. Knowledge is shared from the IT asset management system 106, acting as the active party in the multi-party learning framework, with each of the passive parties 102 utilizing multi-party knowledge distillation logic 168. The knowledge which is shared from the IT asset management system 106 to the passive parties 102 includes restricted “complementary” training targets (e.g., only those components of a label distribution not yet learned by the IT asset management system 106), rather than raw or fully derived label information, which mitigates privacy risks and prevents redundant label leakage. Such complementary training targets are generated utilizing the SCE logic 166. The multi-party knowledge distillation logic 168 also implements backflow distillation (BFD) where the IT asset management system 106 updates its global predictive maintenance machine learning model using newly refined outputs of the local predictive maintenance machine learning models trained by the passive parties 102 (e.g., utilizing the local predictive maintenance model training logic 124). The ART logic 170 provides functionality for continuously adjusting the importance of the output from each of the passive parties 102 based on real-time feature distribution changes.

At least portions of the local predictive maintenance model training logic 124, the multi-party knowledge distillation logic 126, the global predictive maintenance model training logic 160, the IT asset predictive maintenance logic 162, the HCD learning tool 164, the SCE logic 166, the multi-party knowledge distillation logic 168 and the ART logic 170 may be implemented at least in part in the form of software that is stored in memory and executed by a processor.

It is to be appreciated that the particular arrangement of the IT infrastructure 102-1, the software providers 102-2, the hardware suppliers 102-3, the repair service vendors 102-4, the IT asset management system 106 and the client devices 107 illustrated in the FIG. 1 embodiment is presented by way of example only, and alternative arrangements can be used in other embodiments. As discussed above, for example, the IT asset management system 106 (or portions of components thereof, such as one or more of the global predictive maintenance model training logic 160, the IT asset predictive maintenance logic 162, the HCD learning tool 164, the SCE logic 166, the multi-party knowledge distillation logic 168 and the ART logic 170) may in some embodiments be implemented internal to one or more of the passive parties 102, such as the IT infrastructure 102-1.

The IT asset management system 106 and other portions of the information processing system 100, as will be described in further detail below, may be part of cloud infrastructure.

The IT asset management system 106 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The IT infrastructure 102-1, the software providers 102-2, the hardware suppliers 102-3, the repair service vendors 102-4, the IT asset management system 106 and the client devices 107 or components thereof may be implemented on respective distinct processing platforms, although numerous other arrangements are possible. For example, in some embodiments at least portions of the IT asset management system 106 and one or more of the IT infrastructure 102-1, the software providers 102-2, the hardware suppliers 102-3, the repair service vendors 102-4 and/or one or more of the client devices 107 are implemented on the same processing platform. A given one of the client devices 107 can therefore be implemented at least in part within at least one processing platform that implements at least a portion of the IT asset management system 106.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which the IT infrastructure 102-1, the software providers 102-2, the hardware suppliers 102-3, the repair service vendors 102-4, the IT asset management system 106 and/or the client device 107 are geographically distributed (e.g., in different geographic locations that are potentially remote from one another). Numerous other distributed implementations are possible. The IT asset management system 106 can also be implemented in a distributed manner across multiple data centers.

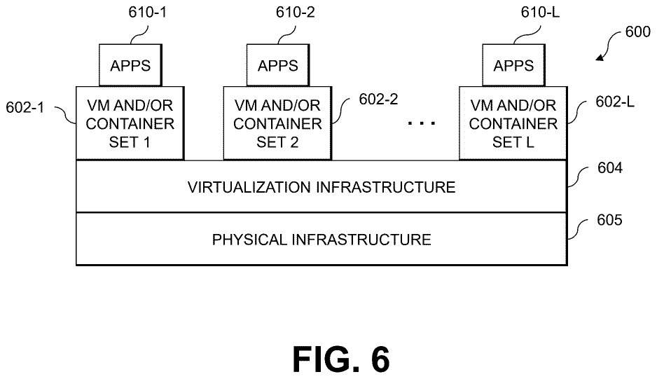

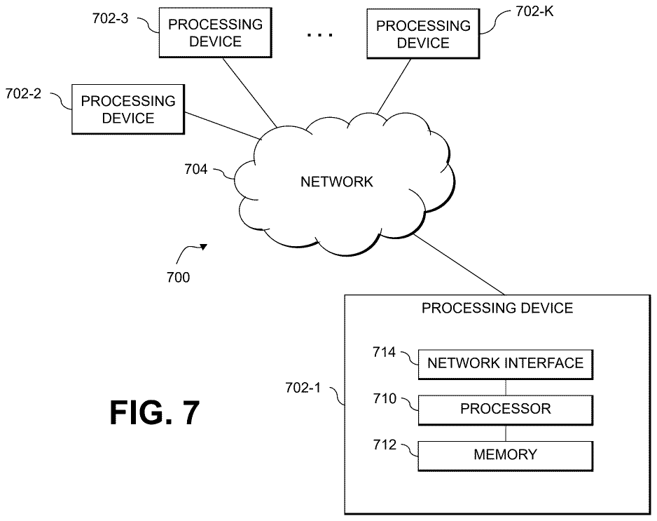

Additional examples of processing platforms utilized to implement the IT infrastructure 102-1, the software providers 102-2, the hardware suppliers 102-3, the repair service vendors 102-4, the IT asset management system 106, the client devices 107 and other components of the information processing system 100 in illustrative embodiments will be described in more detail below in conjunction with FIGS. 6 and 7.

It is to be understood that the particular set of elements shown in FIG. 1 for machine learning-based predictive maintenance for IT assets is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

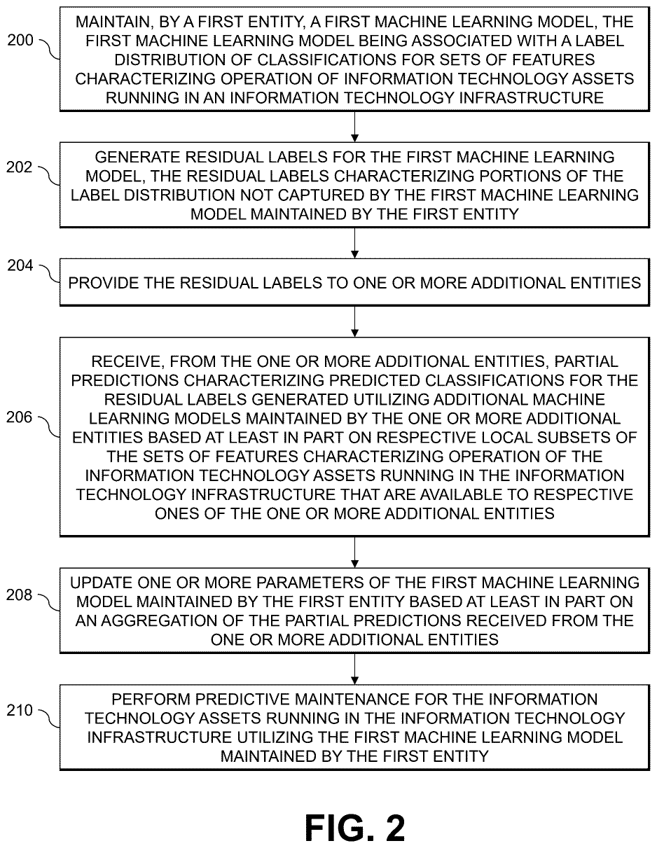

An exemplary process for machine learning-based predictive maintenance for IT assets will now be described in more detail with reference to the flow diagram of FIG. 2. It is to be understood that this particular process is only an example, and that additional or alternative processes for machine learning-based predictive maintenance for IT assets may be used in other embodiments.

In this embodiment, the process includes steps 200 through 210. These steps are assumed to be performed by the IT infrastructure 102-1, the software providers 102-2, the hardware suppliers 102-3, the repair service vendors 102-4 and/or the IT asset management system 106 utilizing the local predictive maintenance model training logic 124, the multi-party knowledge distillation logic 126, the global predictive maintenance model training logic 160, the IT asset predictive maintenance logic 162, the HCD learning tool 164, the SCE logic 166, the multi-party knowledge distillation logic 168 and/or the ART logic 170. The process begins with step 200, maintaining, by a first entity, a first machine learning model. The first machine learning model is associated with a label distribution of classifications for sets of features characterizing operation of IT assets running in an IT infrastructure.

In step 202, residual labels for the first machine learning model are generated. The residual labels characterize portions of the label distribution not captured by the first machine learning model maintained by the first entity. The residual labels are provided to one or more additional entities in step 204. In step 206, partial predictions are received from the one or more additional entities. The partial predictions characterize predicted classifications for the residual labels generated utilizing additional machine learning models maintained by the one or more additional entities based at least in part on respective local subsets of the sets of features characterizing operation of the IT assets running in the IT infrastructure that are available to respective ones of the one or more additional entities. One or more parameters of the first machine learning model maintained by the first entity are updated in step 208 based at least in part on an aggregation of the partial predictions received from the one or more additional entities. Predictive maintenance for the IT assets running in the IT infrastructure is performed in step 210 utilizing the first machine learning model maintained by the first entity.

The first entity and the one or more additional entities may be part of a multi-party vertical federated learning (VFL) framework. The first entity may implement an IT asset management system separate from the IT infrastructure. The one or more additional entities may comprise: one or more software providers providing software running on the IT assets running in the IT infrastructure; one or more hardware suppliers of hardware components that are part of the IT assets running in the IT infrastructure; one or more repair service vendors performing maintenance actions for the IT assets running in the IT infrastructure.

Generating a given one of the residual labels for a given sample may be based at least in part on a logit output of the first machine learning model maintained by the first entity and a ground-truth label distribution for the given sample. The given residual label may be generated by subtracting at least one of a softmax and a logistic sigmoid function of the logit output from the ground-truth label distribution for the given sample.

The partial predictions received from a given one of the one or more additional entities may comprise an intermediate representation distilling latent feature embeddings output by a given one of the additional machine learning models maintained by the given additional entity.

The aggregation of the partial predictions may utilize adaptive weights assigned to the partial predictions received from each of the one or more additional entities. The adaptive weights may be dynamically updated based at least in part on error gradients and/or variance of the partial predictions from each of the one or more additional entities.

Performing the predictive maintenance for the IT assets running in the IT infrastructure comprises utilizing the first machine learning model maintained by the first entity to identify a given one of the IT assets running in the IT infrastructure that is predicted to fail. Performing the predictive maintenance for the IT assets running in the IT infrastructure may further comprise performing one or more maintenance actions on the given IT asset.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Privacy-preserving multi-party learning, particularly in the vertical federated learning (VFL) setting, has been widely explored for scenarios where feature subsets are distributed across multiple parties. Some approaches focus on secure computation methods, including homomorphic encryption and differential privacy, to address label leakage concerns. Such approaches, however, introduce substantial computational overhead, making them impractical for dynamic, real-time applications. Further, these approaches often lack mechanisms for adapting to incomplete or misaligned data distributions, which are common in real-world collaborations.

Other approaches rely on knowledge distillation to enable model collaboration without directly sharing data. For example, some approaches utilize a multi-modal distillation framework to combine heterogeneous features effectively, demonstrating the potential for enhancing model performance. Despite these advancements, these approaches struggle to prevent redundant label exposure and are unable to dynamically adjust to changing data contributions. Some other approaches utilize cross-modal distillation strategies to leverage complementary information across data modalities. These approaches, however, lack robust mechanisms for addressing privacy risks and do not provide real-time adaptability.

In some approaches, dynamic learning frameworks attempt to integrate full or missing modalities dynamically for specific tasks like land-use classification. While these approaches exhibit some adaptability, these approaches often fail to address the complexities of incomplete alignment and fail to provide privacy protection in multi-party scenarios. Moreover, such approaches typically focus on one-way knowledge transfer, limiting the benefits of multi-directional collaboration.

Illustrative embodiments provide technical solutions for implementing robust, privacy-preserving multi-party learning via the HCD framework (e.g., HCD learning tool 164), which addresses various technical challenges associated with other approaches for multi-party learning. In some embodiments, the HCD framework is tailored for device fault prediction and proactive maintenance (e.g., for IT assets in an IT infrastructure environment, such as IT assets 120 of IT infrastructure 102-1). Thus, the technical solutions in some embodiments are able to address technical challenges associated with implementing device predictive maintenance services, through leveraging cross-organization data collaboration to enhance accuracy while protecting confidential information.

The HCD framework is designed for robust model training and servicing in scenarios where data is distributed among multiple parties with varying feature sets, incomplete alignment, and stringent privacy requirements. The HCD framework, in some embodiments, introduces a technique referred to as SCE for generating “complementary” training targets. Instead of sharing raw or fully derived label information, only those components of the label distribution not yet learned by a main (active) party are transferred to passive parties. Advantageously, this mitigates privacy risks and prevents redundant label leakage. The HCD framework may employ multiple complementary distillation strategies, including: IPT which allows passive parties to learn from each other's intermediate representations; and BFD which allows the main or active party to periodically update its machine learning model using newly-refined outputs of the passive parties. Further, to accommodate dynamic data conditions, the HCD framework in some embodiments integrates an ART module that is configured to continuously adjust the importance of each passive party's output based on real-time feature distribution changes.

The HCD framework described herein provides various technical advantages, including the ability to maintain high prediction accuracy under misaligned data conditions, the ability to ensure minimal label leakage risk, and the ability to dynamically adapt to evolving data. The HCD framework may be utilized in various application scenarios, including predictive maintenance services, demonstrating value in safeguarding privacy while boosting overall system performance.

The technical solutions described herein implement the HCD framework which provides various technical advantages, including providing features such as label privacy protection, dynamic data adaptation, cross-party knowledge transfer, robustness to misaligned data, and two-way collaboration. The HCD framework introduces SCE to restrict shared label information to residuals, mitigating privacy risks and providing label privacy protection. In some embodiments, the HCD framework utilizes two-way distillation including IPT and BFD, enabling bidirectional knowledge sharing among parties (e.g., enabling cross-party knowledge transfer and two-way collaboration). Additionally, the ART module of the HCD framework in some embodiments is able to dynamically adjust learning weights to ensure robustness under misaligned or evolving data conditions (e.g., enabling dynamic data adaptation and providing robustness to misaligned data).

The HCD framework introduces SCE to ensure minimal leakage of active party labels. Under SCE, label information that the active party's machine learning model has already captured is subtracted out, leaving only “residual” label information to be distilled to passive parties. With the HCD framework, two distillation pathways are used to harness complementary knowledge: IPT and BFD. In IPT, passive parties collectively share intermediate embeddings among themselves to capture non-overlapping feature representations, thus reinforcing each party's local machine learning model. In BFD, the active party periodically incorporates refined knowledge (e.g., the sum or aggregation of passive party outputs) to enhance its own model performance. Additionally, the HCD framework includes a dynamic learning component referred to as ART, which is configured to recalibrate residual encoding and distillation weights in real-time, responding to the changing distribution of features and the importance of each passive party's contribution. By doing so, the HCD framework maintains reliability even as data conditions shift or certain passive parties become stragglers.

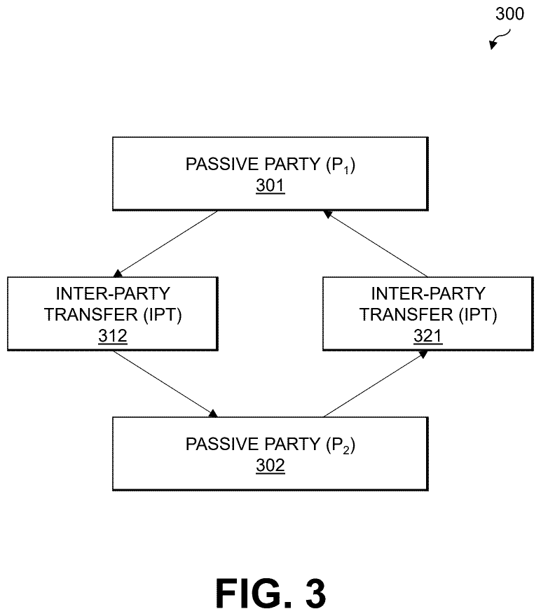

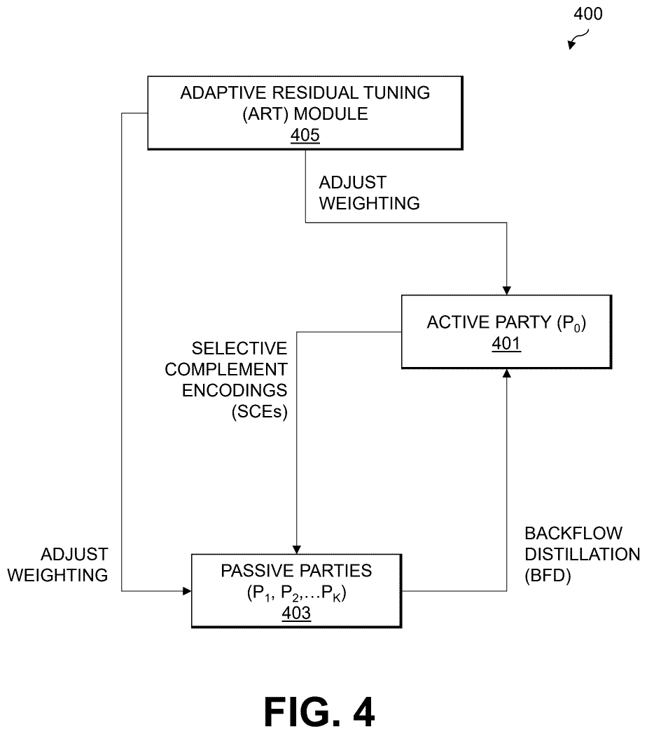

FIGS. 3 and 4 show respective process flows 300 and 400 of an overall worklow of an HCD process, highlighting interactions among an active party (P₀) and passive parties (P₁, P₂, . . . . Pₖ). Arrows in FIGS. 3 and 4 represent the flow of knowledge and data exchange. FIG. 3 illustrates an IPT process flow 300, where a first passive party 301 and a second passive party 302 engage in IPT, including IPT 312 from the first passive party 301 (P₁) to the second passive party 302 (P₂), and IPT 321 from the second passive party 302 to the first passive party 301. FIG. 4 illustrates a process flow 400 including SCE, BFD and ART functionality. In the process flow 400, there is an active party 401 (P₀), a set of passive parties 403 (P₁, P₂, . . . . P_{K}), and an ART module 405. The active party 401 provides SCEs to the passive parties 403, and the passive parties 403 provide BFD to the active party 401. The ART module 405 provides a control module that dynamically adjusts the weightings of distillation processes performed by the active party 401 and the passive parties 403, ensuring optimal knowledge transfer across the system. FIGS. 3 and 4 visually convey the bidirectional and adaptive nature of the HCD process, emphasizing its collaborative and iterative structure. In summary, the HCD process provides: robustness through adaptive aggregation of partial outputs; privacy protection via SCE that restricts shared label information to only what has not been learned by the active party; two-way distillation to ensure all parties benefit from each other's knowledge; and dynamic adaptability through ART to handle real-world, continuously changing environments.

Consider a set of entities, also referred to as parties, collaborating under a VFL paradigm. One central “active” party P₀ has both the input features X, and ground-truth labels Y. The remaining parties {P₁, P₂, . . . . P_{K}} (e.g., “passive” parties) each hold feature subsets X₁, X₂, . . . . X_{K}, but do not possess the labels. The goal is to train a unified predictive machine learning model that yields accurate inferences even when data from some parties is missing, while preventing reverse-engineering of the labels by any passive party.

To address label privacy, the HCD framework implements SCE. Let ƒ_{θ}(i) be the active party's logit output for sample i (e.g., representing a main or “global” machine learning model), and let p_{gt}(y|i) denote the ground-truth label distribution (e.g., one-hot, softmax, etc.) for that sample. The goal is to produce residual labels:

$${p}_{res} ( i , y ) = {p}_{gt} ( y \vert i ) - σ ( {f}_{θ} ( i ) ) ,$$

where σ(⋅) represents the softmax or logistic sigmoid function, depending on the classification task. The encoded target pᵣₑₛ(i,y) is provided to passive parties so that they learn only the portion of the label distribution not already captured by ƒ_{θ}(i). During training, each passive party Pₖ learns a bottom (e.g., “local”) machine learning model h_{ψ}_{ₖ} to predict pᵣₑₛ(i) from its local features Xₖ. This approach reduces redundant label exposure and prevents passive parties from inferring the complete label distribution.

The performance of the HCD framework stems from carefully orchestrated knowledge distillation in two directions: (1) inter-party transfer, IPT; and (2) backflow distillation, BFD. For IPT, each passive party aggregates intermediate representations from other passive parties. Let vₖ(i) be the latent feature embedding output by party Pₖ. IPT involves a fusion function I that combines {vⱼ(i)}_{j≠k} into a distilled embedding shared with Pₖ. The passive party Pₖ then updates its parameters dk by minimizing a suitable divergence or mean-squared error loss relative to these combined embeddings. For BFD, after passive party machine learning models are updated, the passive parties send their complements h_{ψ}_{ₖ}(i) to the active party. The active party aggregates these predicted complements:

$${H}_{sum} ( i ) = {\sum }_{k = 1}^{K} {h}_{{ψ}_{k}} ( i ) ,$$

and refines its model parameters θ by using the “pseudo-teacher” distribution σ(ƒ_{θ}(i)+Hₛᵤₘ(i)). This ensures that the active party learns from any feature insights discovered by passive parties.

To handle dynamic data settings (e.g., changes in feature importance or distribution shifts), the HCD framework incorporates a dynamic learning component, referred to herein as Adaptive Residual Tuning or ART. ART continuously updates the scaling factors for each party's contribution. Formally, let αₖ be the adaptive weight assigned to passive party k. The aggregated complement at iteration t becomes:

$${H}_{agg}^{( t )} ( i ) = {\sum }_{k = 1}^{K} {α}_{k}^{( t )} {h}_{{ψ}_{k}}^{( t )} ( i ) ,$$

$$where {α}_{k}^{( t )}$$

is updated via an online optimization rule that considers, for instance, the party's recent error gradient or the variance of the partial predictions. This mechanism allows real-time fine-tuning, making the HCD framework robust to missing or delayed data from certain parties.

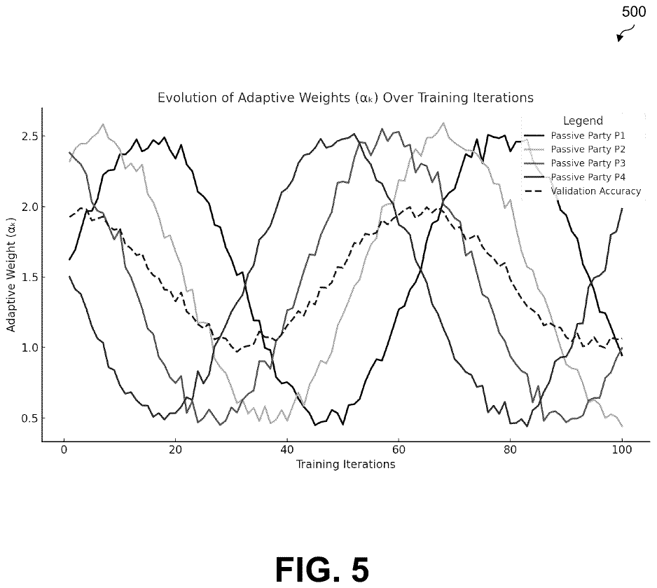

FIG. 5 shows a chart 500 illustrating the evolution of the adaptive weights (αₖ) over training iterations. The chart 500 includes multiple lines illustrating the dynamic adjustment of the adaptive weights (αₖ) for each of a set of four passive parties (P₁, P₂, P₃ and P₄) over the course of training iterations. Each line represents a passive party's contribution, evolving uniquely as determined by the ART module of the HCD framework. The dashed line indicates the overall performance metric (e.g., validation accuracy), providing a visual correlation between the adjustment of weights and system performance. The chart 500 highlights ART's ability to adaptively prioritize contributions based on residual prediction quality and shifting data distributions.

A training workflow for the HCD framework will now be described:
1. Initialization: at initialization, the active party P₀ trains the main or global machine learning model ƒ_{θ} on (X₀,Y). Each passive party Pₖ initializes its bottom or local machine learning model h_{ψ}_{ₖ} with random parameters.
2. Selective Residual Computation: for each mini-batch b, the active party computes residual targets:

$${p}_{res} ( i , y ) = {p}_{gt} ( y \vert i ) - σ ( {f}_{θ} ( i ) )$$

These residual targets are sent to the respective passive parties.
3. Passive Party Updates: each passive party Pₖ updates hox to predict pᵣₑₛ(i,y). IPT is then used for the passive parties to share intermediate embeddings to distill complementary feature insights from one another.
4. Active Party Backflow: the active party collects partial predictions h_{ψ}_{ₖ}(i) from all passive parties and forms Hₛᵤₘ(i). BFD is then used, where the active party's machine learning model parameters θ are updated using σ(ƒ_{θ}(i)+Hₛᵤₘ(i)) as the teacher signal.
5. Adaptive Residual Tuning: the ART module continuously adjusts the weights αₖ to optimize performance given the latest distribution shifts or data quality variations.
6. Convergence: (1)-(5) are iterated until convergence, yielding a robust multi-party machine learning model architecture.

Once trained, each party locally infers its partial outputs. The active party aggregates available partial outputs (even if some parties are missing) and computes the final prediction via:

$${\hat{z}}_{i} = σ ( {f}_{θ} ( i ) + {g}_{λ} ( {h}_{{ψ}_{k}} ( i ) ) ) ,$$

where g_{λ}(⋅) is an aggregator (e.g., sum or small neural network). Because the passive parties only learn the residual labels, privacy risks are substantially mitigated.

The technical solutions described herein provide the HCD framework with: SCE to transform the active party's label information into residual labels for passive parties; IPT to enable cross-party knowledge sharing; BFD to update the active party's machine learning model with refined complements; and ART to dynamically adjust residual weights in response to evolving data distributions. The SCE may use a label residual computation of the form:

$${p}_{res} ( i , y ) = {p}_{gt} ( y \vert i ) - σ ( {f}_{θ} ( i ) ) ,$$

such that only unlearned portions of the label distribution are accessible to passive parties, thereby preventing full label inference and enhancing privacy protection. The ART module is configured to dynamically update party-specific weights

$${α}_{k}^{( t )}$$

based on real-time error gradients, enabling robust handling of straggling or misaligned data in vertical federated learning setups.

In a predictive maintenance system, multiple entities collaborate to predict failures (e.g., hardware and/or software failures) in IT assets (e.g., IT assets 120 representing enterprise devices of an enterprise in an IT infrastructure 102-1 being monitored by the IT asset management system 106 implementing a predictive maintenance service). In this example, the IT asset management system 106 is the “active” party, which possesses key telemetry features X₀ and historical failure labels Y (e.g., which may be maintained as part of usage environment metrics data store 122-1). The IT asset management system 106 trains a main machine learning model ƒ_{θ} to perform baseline classification. The passive parties may include IT infrastructure 102-1 (e.g., enterprise IT systems) holding detailed usage environment metrics (e.g., maintained in usage environment metrics data store 122-1), software providers 102-2 tracking application performance data (e.g., maintained in application performance metrics data store 122-2), hardware suppliers 102-3 offering component performance logs (e.g., maintained in component performance metrics data store 122-3), and repair service vendors 102-4 contributing maintenance histories (e.g., maintained in maintenance history data store 122-4). The data flow includes the passive parties (e.g., IT infrastructure 102-1, software providers 102-2, hardware suppliers 102-3 and repair service vendors 102-4) receiving SCEs pᵣₑₛ(i,y) of the fault labels. The passive parties train local machine learning models h_{ψ}_{ₖ} to capture the residual signals from their respective feature sets. IPT allows the IT infrastructure 102-1 to share intermediate embeddings (e.g., of its enterprise IT system machine learning model) with the hardware suppliers 102-3, and vice versa (e.g., sharing intermediate embeddings of the hardware supplier machine learning model with the IT infrastructure 102-1), ensuring each better understands cross-dependent feature relationships. IPT may also be used for information sharing amongst other ones of the passive parties. BFD returns the aggregated residual predictions to the IT asset management system 106, enhancing its main or global machine learning model with new insights on real-time usage patterns or hardware anomalies. ART automatically adjusts the weighting of each passive party's contribution to handle data delays or missing features (e.g., from software providers 102-2, repair service vendors 102-4, etc.). Service integration includes, during inference, the main machine learning model (e.g., ƒ_{θ} of the IT asset management system 106) and any available passive party machine learning models (e.g., h_{ψ}_{ₖ} of the passive parties 102) each producing partial predictions. The final predictive distribution (e.g., whether one of the IT assets 120 has or is predicted to experience failure) is computed by the IT asset management system 106, improving fault detection with minimal service downtime. Sensitive labels remain secure, as the residual transformation in SCE never reveals complete label distributions to passive parties.

By adopting the HCD framework in a predictive maintenance system, an enterprise or other entity and its collaborating partners will be able to achieve higher fault detection accuracy through complementary features, maintain robust inference under intermittent data availability, and ensure that enterprise-level privacy and data production standards are upheld.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based predictive maintenance for IT assets will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based predictive maintenance for IT assets as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to maintain, by a first entity, a first machine learning model, the first machine learning model being associated with a label distribution of classifications for sets of features characterizing operation of information technology assets running in an information technology infrastructure;
to generate residual labels for the first machine learning model, the residual labels characterizing portions of the label distribution not captured by the first machine learning model maintained by the first entity;
to provide, to one or more additional entities, the residual labels;
to receive, from the one or more additional entities, partial predictions characterizing predicted classifications for the residual labels generated utilizing additional machine learning models maintained by the one or more additional entities based at least in part on respective local subsets of the sets of features characterizing operation of the information technology assets running in the information technology infrastructure that are available to respective ones of the one or more additional entities; and
to update one or more parameters of the first machine learning model maintained by the first entity based at least in part on an aggregation of the partial predictions received from the one or more additional entities.

2. The apparatus of claim 1 wherein the first entity and the one or more additional entities are part of a multi-party vertical federated learning framework.

3. The apparatus of claim 1 wherein the first entity implements an information technology asset management system separate from the information technology infrastructure.

4. The apparatus of claim 1 wherein the one or more additional entities comprise one or more software providers providing software running on the information technology assets running in the information technology infrastructure.

5. The apparatus of claim 1 wherein the one or more additional entities comprise one or more hardware suppliers of hardware components that are part of the information technology assets running in the information technology infrastructure.

6. The apparatus of claim 1 wherein the one or more additional entities comprise one or more repair service vendors performing maintenance actions for the information technology assets running in the information technology infrastructure.

7. The apparatus of claim 1 wherein generating a given one of the residual labels for a given sample is based at least in part on a logit output of the first machine learning model maintained by the first entity and a ground-truth label distribution for the given sample.

8. The apparatus of claim 7 wherein the given residual label is generated by subtracting at least one of a softmax and a logistic sigmoid function of the logit output from the ground-truth label distribution for the given sample.

9. The apparatus of claim 1 wherein the partial predictions received from a given one of the one or more additional entities comprise an intermediate representation distilling latent feature embeddings output by a given one of the additional machine learning models maintained by the given additional entity.

10. The apparatus of claim 1 wherein the aggregation of the partial predictions utilizes adaptive weights assigned to the partial predictions received from each of the one or more additional entities.

11. The apparatus of claim 10 wherein the adaptive weights are dynamically updated based at least in part on error gradients of the partial predictions from each of the one or more additional entities.

12. The apparatus of claim 10 wherein the adaptive weights are dynamically updated based at least in part on variance of the partial predictions from each of the one or more additional entities.

13. The apparatus of claim 1 wherein the at least one processing device is further configured to perform predictive maintenance for the information technology assets running in the information technology infrastructure utilizing the first machine learning model maintained by the first entity.

14. The apparatus of claim 13 wherein performing the predictive maintenance for the information technology assets running in the information technology infrastructure comprises:
utilizing the first machine learning model maintained by the first entity to identify a given one of the information technology assets running in the information technology infrastructure that is predicted to fail; and
performing one or more maintenance actions on the given information technology asset.

15. A computer program product comprising a non-transitory processor-readable storage medium having stored therein program code of one or more software programs, wherein the program code when executed by at least one processing device causes the at least one processing device:
to maintain, by a first entity, a first machine learning model, the first machine learning model being associated with a label distribution of classifications for sets of features characterizing operation of information technology assets running in an information technology infrastructure;
to generate residual labels for the first machine learning model, the residual labels characterizing portions of the label distribution not captured by the first machine learning model maintained by the first entity;
to provide, to one or more additional entities, the residual labels;
to receive, from the one or more additional entities, partial predictions characterizing predicted classifications for the residual labels generated utilizing additional machine learning models maintained by the one or more additional entities based at least in part on respective local subsets of the sets of features characterizing operation of the information technology assets running in the information technology infrastructure that are available to respective ones of the one or more additional entities; and
to update one or more parameters of the first machine learning model maintained by the first entity based at least in part on an aggregation of the partial predictions received from the one or more additional entities.

16. The computer program product of claim 15 wherein generating a given one of the residual labels for a given sample is based at least in part on a logit output of the first machine learning model maintained by the first entity and a ground-truth label distribution for the given sample.

17. The computer program product of claim 15 wherein the aggregation of the partial predictions utilizes adaptive weights assigned to the partial predictions received from each of the one or more additional entities.

18. A method comprising:
maintaining, by a first entity, a first machine learning model, the first machine learning model being associated with a label distribution of classifications for sets of features characterizing operation of information technology assets running in an information technology infrastructure;
generating residual labels for the first machine learning model, the residual labels characterizing portions of the label distribution not captured by the first machine learning model maintained by the first entity;
providing, to one or more additional entities, the residual labels;
receiving, from the one or more additional entities, partial predictions characterizing predicted classifications for the residual labels generated utilizing additional machine learning models maintained by the one or more additional entities based at least in part on respective local subsets of the sets of features characterizing operation of the information technology assets running in the information technology infrastructure that are available to respective ones of the one or more additional entities; and
updating one or more parameters of the first machine learning model maintained by the first entity based at least in part on an aggregation of the partial predictions received from the one or more additional entities;
wherein the method is performed by at least one processing device comprising a processor coupled to a memory.

19. The method of claim 18 wherein generating a given one of the residual labels for a given sample is based at least in part on a logit output of the first machine learning model maintained by the first entity and a ground-truth label distribution for the given sample.

20. The method of claim 18 wherein the aggregation of the partial predictions utilizes adaptive weights assigned to the partial predictions received from each of the one or more additional entities.
